(19) United States
(12) Patent Application Publication
(10) Pub. No.: US 2026/0072722 A1
(43) Pub. Date: Mar. 12, 2026

(54) System-on-Chip Providing Virtualized Environment, Virtualized System, and Operating Method of the Virtualized System

(71) Applicant: Samsung Electronics Co., Ltd., Suwon-si (KR)

(72) Inventors: Jungtae Kim, Suwon-si (KR); Keunyoung Park, Suwon-si (KR); Dongjin Park, Suwon-si (KR); Taein An, Suwon-si (KR); Buyoung Yun, Suwon-si (KR)

(21) Appl. No.: 19/242,647

(22) Filed: Jun. 18, 2025

(30) Foreign Application Priority Data
Sep. 12, 2024 (KR) 10-2024-0124996

(51) Int. Cl. G06F 9/455; G06F 12/1081; G06F 15/78

(52) U.S. Cl. CPC G06F 9/45558; G06F 12/1081; G06F 15/7807; G06F 2009/45579; G06F 2009/45583

(57) ABSTRACT

A system-on-chip includes an input output (IO) device configured to perform a direct memory access operation on a memory, an access control device configured to search for mapping information between a plurality of virtual identifiers respectively corresponding to a plurality of virtual machines, and block the direct memory access operation based on the search result, and a host processor configured to provide, to the access control device, a target address accessed by the direct memory access operation and a target virtual identifier corresponding to a driving virtual machine driving the IO device.

### CROSS-REFERENCE TO RELATED APPLICATION

This application claims priority to Korean Patent Application No. 10-2024-0124996, filed in the Korean Intellectual Property Office on Sep. 12, 2024, the disclosure of which is incorporated by reference herein in its entirety.

### BACKGROUND

In a mobile environment, a large capacity of computing resources, such as on-device artificial intelligence (AI), is required, and at the same time, services using input/output (IO) devices, such as a neural processing unit (NPU) and a graphics processing unit (GPU), are increasing.

Because various services share limited IO devices, there is a need for a method of ensuring memory isolation between various services and efficiently sharing the IO devices.

### SUMMARY

In general, the present disclosure is directed toward a system-on-chip that isolates a storage area of a memory accessible for each virtual machine, and controls an input/output (IO) device based on a virtual identifier corresponding to each virtual machine.

According to some implementations, the present disclosure is directed to a system-on-chip that includes an input output (IO) device configured to perform a direct memory access operation on a memory, an access control device configured to search for mapping information between a plurality of virtual identifiers respectively corresponding to a plurality of virtual machines, and block the direct memory access operation based on a result of searching for the mapping information, and a host processor configured to provide, to the access control device, a target address accessed by the direct memory access operation and a target virtual identifier corresponding to a driving virtual machine configured to drive the IO device.

According to some implementations, the present disclosure is directed to a virtualized system that includes a memory, a processor configured to provide a virtualized environment, at least one input output (IO) device configured to perform a memory access operation on the memory, a plurality of virtual machines configured to independently operate in the virtualized environment and generate requests for the memory access operation, a virtual identification (VID) generator configured to store a virtual identifier of a driving virtual machine configured to drive the at least one IO device among the plurality of virtual machines, an access control device configured to block the memory access operation based on first mapping information between a plurality of virtual identifiers respectively corresponding to the plurality of virtual machines and on the virtual identifier of the driving virtual machine, and a hypervisor configured to control the plurality of virtual machines in the virtualized environment, update the first mapping information onto the access control device, and store the virtual identifier of the driving virtual machine in the VID generator.

According to some implementations, the present disclosure is directed to an operating method of a virtualized system that includes generating virtual identifiers mapped to virtual machine identifiers of a plurality of virtual machines, allocating addresses of a memory to the plurality of virtual machines, generating mapping information between the virtual identifiers of the plurality of virtual machines and the addresses allocated to the plurality of virtual machines, obtaining a first virtual identifier mapped to a virtual machine identifier of the first virtual machine, based on a usage request for an input output (IO) device of a first virtual machine among the plurality of virtual machines, searching for the mapping information based on the first virtual identifier, and a first address related to the usage request, and controlling access to the memory of the IO device based on a result of searching for the mapping information.

### BRIEF DESCRIPTION OF THE DRAWINGS

Example implementations will be more clearly understood from the following detailed description, taken in conjunction with the accompanying drawings.

FIG. 1 is a block diagram showing an example of an electronic device according to some implementations.

FIG. 2 is a block diagram showing an example of a virtualized system according to some implementations.

FIG. 3 is a diagram showing an example of an access control table address register and an access control table according to some implementations.

FIG. 4 is a diagram showing an example of a virtual identifier mapping table according to some implementations.

FIG. 5 is a block diagram showing an example of a virtualized system according to some implementations.

FIG. 6 is a block diagram showing an example of an electronic device according to some implementations.

FIG. 7 is a block diagram showing an example of an electronic device according to some implementations.

FIG. 8 is a block diagram showing an example of an electronic device according to some implementations.

FIG. 9 is a block diagram showing an example of an electronic device according to some implementations.

FIG. 10 is a diagram showing an example of an address conversion operation according to some implementations.

FIG. 11 is a flowchart of an example of an operating method of a virtualized system according to some implementations.

FIG. 12 is a block diagram showing an example of an electronic device according to some implementations.

FIG. 13 is a block diagram showing an example of an autonomous driving system according to some implementations.

### DETAILED DESCRIPTION

Hereinafter, example implementations will be described in detail with reference to the accompanying drawings.

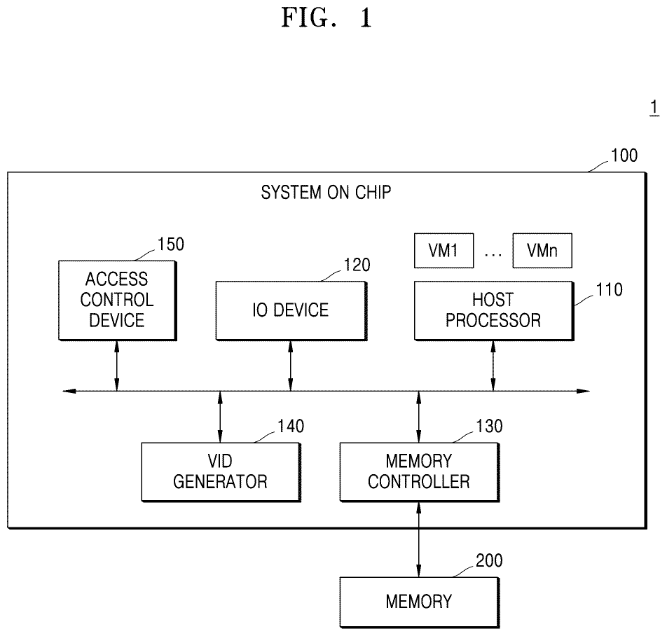

FIG. 1 is a block diagram showing an example of an electronic device according to some implementations. In FIG. 1, an electronic device 1 may include a system-on-chip (SoC) 100 and a memory 200. The SoC 100 may be connected to components of the electronic device 1, and may perform operations or data processing related to control and/or communication of each component. The memory 200 may include a volatile memory. For example, the memory 200 may include dynamic random access memory (RAM) (DRAM), static RAM (SRAM), and magnetic RAM (MRAM). However, the present disclosure is not limited thereto, and the memory 200 may include a non-volatile memory.

The SoC 100 may include a host processor 110, an input/output (IO) device 120, a memory controller 130, a virtual identification (VID) generator 140, and an access control device 150. The host processor 110 may control an operation of the SoC 100. The host processor 110 may manage requests from various applications, software, virtual machines VM1 through VMn, or the like, which are driven on the SoC 100. The virtual machines VM1 through VMn may drive the IO device 120 to access the memory 200.

The IO device 120 may perform a direct memory access operation of directly accessing the memory 200 according to control by the host processor 110. The IO device 120 may include a neural processing unit (NPU), a graphics processing unit (GPU), a digital signal processor (DSP), an image signal processor (ISP), a peripheral component interconnect express (PCIe) device, a universal serial bus (USB) device, etc. Although FIG. 1 illustrates one IO device 120, the present disclosure is not limited thereto. The IO device 120 may be referred to as an intellectual property (IP) block, a functional block, or an accelerator.

The memory controller 130 may control access to the memory 200. For example, the memory controller 130 may schedule access of the host processor 110 and the IO device 120 to the memory 200.

The VID generator 140 may store the virtual identification VID for identifying a virtual machine which operates the IO device 120, among the virtual machines VM1 through VMn, based on the control of the host processor 110. The host processor 110 may generate the virtual identification VID mapped to a virtual machine identifier VMID of a virtual machine operating the IO device 120, and may set the virtual identification VID in the VID generator 140. The VID generator 140 may be implemented as a register, a buffer, etc.

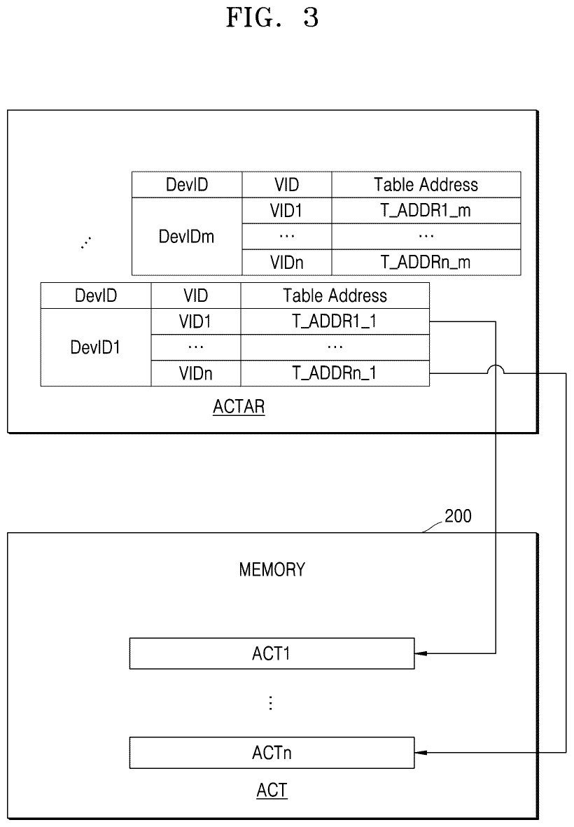

The access control device 150 may manage the storage area of the memory 200 that is accessible by the IO device 120, that is, addresses. The access control device 150 may manage mapping information between the virtual identification VID and addresses of the memory 200. The address may include a physical address for the memory 200 or a virtual address. For example, the access control device 150 may manage the access control table address register ACTAR and the access control table ACT in FIG. 3. The access control device 150 may allow or block access to the memory 200 of the virtual machines VM1 through VMn, based on the mapping information. The memory 200 may store the virtual machines VM1 through VMn and the access control table ACT.

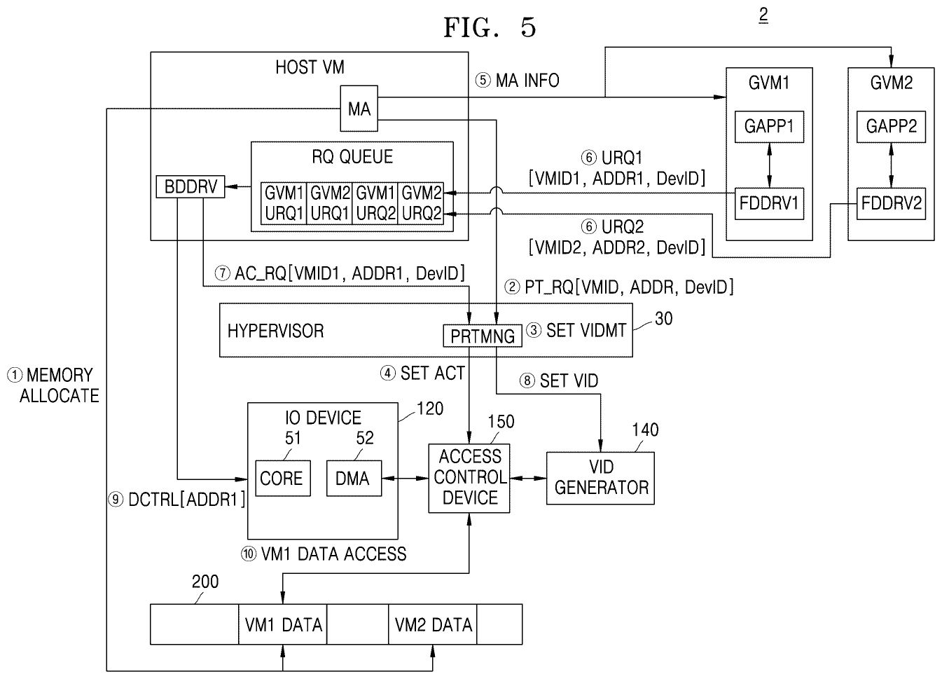

In some implementations, the IO device 120 may perform a direct memory access operation on the memory 200, based on a device control signal of the host processor 110 (for example, DCTRL in FIG. 5). The IO device 120 may provide a direct memory access DMA request to the access control device 150, based on the address included in a device control signal (for example, DCTRL in FIG. 5). The access control device 150 may search for the mapping information based on the virtual identification VID generated by the VID generator 140 and the address included in the DMA request, and depending on the searching result, may allow or block access of the IO device 120 to the memory 200.

Because an allowance of the access control device 150 is needed so that each of the virtual machines VM1 through VMn drives the IO device 120 to access the memory 200, the storage areas accessible by the virtual machines VM1 through VMn may be provided with a memory isolation function to isolate the virtual machines VM1 through VMn from each other. In other words, according to some implementations, because the storage areas accessible by the virtual machines VM1 through VMn while the virtual machines VM1 through VMn share the IO device 120 are isolated, an improved security performance may be provided.

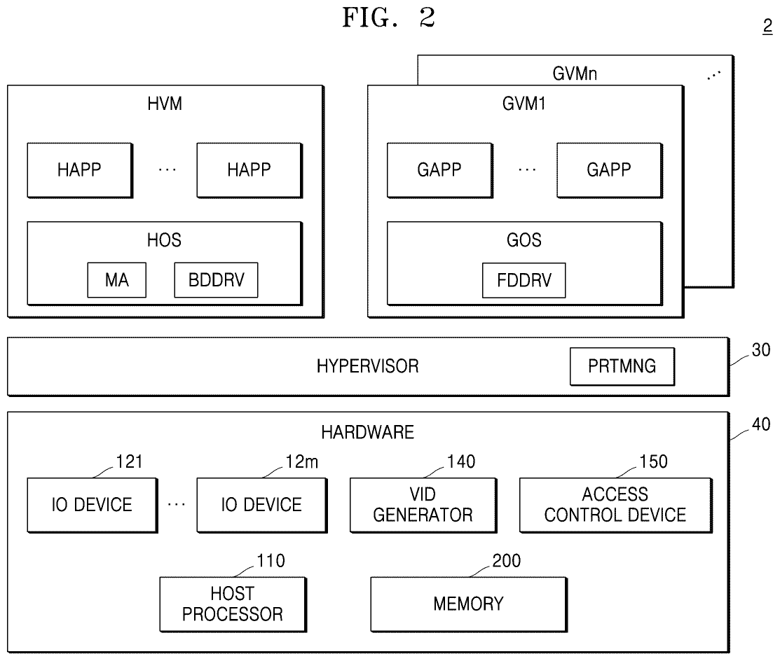

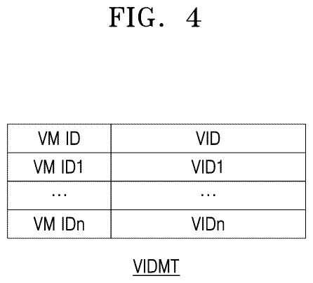

FIG. 2 is a block diagram showing an example of a virtualized system according to some implementations. FIG. 3 is a diagram showing an example of the access control table address register ACTAR and the access control table ACT according to some implementations. FIG. 4 is a diagram showing an example of a virtual identifier mapping table VIDMT according to some implementations.

In FIG. 2, a virtualized system 2 may include host applications HAPP, a host operating system HOS, guest applications GAPP, a guest operating system GOS, a hypervisor 30, and hardware 40. The hardware 40 may correspond to the electronic device 1 of FIG. 1, and may include the host processor 110, a plurality of IO devices 121 through 12m (m is an integer greater than one), the VID generator 140, the access control device 150, and the memory 200. However, the present disclosure is not limited thereto, and the hardware 40 may further include other physical hardware devices.

The host processor 110 may provide a function to implement a virtualized environment. The host applications HAPP, the host operating system HOS, the guest applications GAPP, the guest operating system GOS, and the hypervisor 30 may run in the virtualized environment. For example, the host operating system HOS may run on a host virtual machine HVM in the virtualized environment, and the guest operating system GOS may run on the guest virtual machine GVM1 in the virtualized environment and run independently of the host operating system HOS. Descriptions of the guest virtual machine GVM1 may be applied to other guest virtual machines GVM2 through GVMn. The host applications HAPP may run on the host operating system HOS. The guest applications GAPP may run on the guest operating system GOS. The hypervisor 30 may implement the virtualized environment by using a function of the hardware 40, and may generate and control the host virtual machine HVM and the guest virtual machines GVM1 through GVMn in the virtualized environment.

The number of guest virtual machines driving on the hypervisor 30 may be variously determined according to the virtualized environment.

The host operating system HOS may include a memory allocator MA and a back-end device driver BDDRV. The memory allocator MA may allocate the storage area of the memory 200, that is, the address, to the host virtual machine HVM and the guest virtual machines GVM1 through GVMn. The memory allocator MA may allocate the virtual addresses of the memory 200 to the host virtual machine HVM and the guest virtual machines GVM1 through GVMn. The memory allocator MA may provide a protection request (for example, PT_RQ in FIG. 5) to a protection manager PRTMNG of the hypervisor 30 so that only a virtual machine set for the allocated virtual address may access, that is, so that the storage areas allocated to the virtual machines are isolated. The protection request PT_RQ may include the virtual address of the storage area to be protected, and the virtual machine identifier VMID of the virtual machine having access authority to the corresponding storage area.

The back-end device driver BDDRV may receive a usage request for the IO devices 121 through 12m (for example, URQ1 and UQ2 in FIG. 5) from the guest virtual machines GVM1 through GVMn. The back-end device driver BDDRV may provide an access control request for the IO devices 121 through 12m (for example, AC_RQ in FIG. 5) to the protection manager PRTMNG, before driving the IO devices 121 through 12m based on the usage requests URQ1 and URQ2. When the access control operation is completed based on the access control request, the back-end device driver BDDRV may run the IO devices 121 through 12m based on the usage requests URQ1 and URQ2.

The guest operating system GOS may include a front-end device driver FDDRV. When the guest application GAPP requests the driving of the IO devices 121 through 12m, the front-end device driver FDDRV may provide a usage request for the IO devices 121 through 12m (for example, URQ1 and URQ2 in FIG. 5) to the back-end device driver BDDRV. The usage requests URQ1 and URQ2 may include the virtual address to be accessed by the IO devices 121 through 12m and the virtual machine identifier VMID of the guest virtual machine GVM1.

The hypervisor 30 may include the protection manager PRTMNG. In FIG. 3, the protection manager PRTMNG may manage the access control table ACT and the access control table address register ACTAR for limiting the storage area accessible by the IO devices 121 through 12m, based on the protection request received from the memory allocator MA (for example, PT_RQ in FIG. 5). The access control table address register ACTAR may store a table address mapped to the virtual identification VID, for each of device identifiers DevID1 through DevIDm of the IO devices 121 through 12m. For example, the access control table address register ACTAR may store table addresses T_ADDR1_1 through T_ADDRn_1 mapped to the virtual identifiers VID1 through VIDn, for the device identifier DevID1 of the IO device 121. In addition, the access control table address register ACTAR may store table addresses T_ADDR1_m through T_ADDRn_m mapped to the virtual identifiers VID1 through VIDn, for the device identifier DevIDm of the IO device 12m. A table address may include an address indicating storage areas of the memory 200 in which the access control table ACT is stored. For example, an address may include a physical address or a virtual address. According to some implementations, because the range of addresses accessible by each IO device may vary, a device identifier DevID may also be referred to as a memory isolation type.

The access control table ACT may include information about the addresses allocated to the virtual identifiers VID1 through VIDn. For example, the access control table ACT may include bitmap information for differentiating the storage areas of the memory 200 allocated to the virtual identifiers VID1 through VIDn. For example, the access control table ACT may include bitmap information for indicating accessible physical addresses or virtual addresses, for each of the virtual identifiers VID1 through VIDn. Although only the access control table ACT corresponding to the device identifier DevID1 is illustrated in FIG. 3, the memory 200 may store the access control tables corresponding to the device identifiers DevID1 through DevIDm.

In addition, in FIG. 4, the protection manager PRTMNG may manage the virtual identifier mapping table VIDMT for mapping information between the virtual machine identifier VMID and the virtual identification VID. The virtual identifier mapping table VIDMT may be stored in the memory 200, but the embodiment is not limited thereto. The virtual identifier mapping table VIDMT may also be stored in a register, a memory, or the like in the host processor 110. The protection manager PRTMNG may convert the virtual machine identifier VMID into the virtual identification VID, based on an access control request (for example, AC_RQ in FIG. 5) received from the back-end device driver BDDRV, and may set the virtual identification VID in the VID generator 140. The VID generator 140 may store the virtual identification VID set by the protection manager PRTMNG.

The plurality of IO devices 121 through 12m may directly access the memory 200 under control by the host virtual machine HVM, the guest virtual machines GVM1 through GVMn, or the host processor 110 driven by the hypervisor 30.

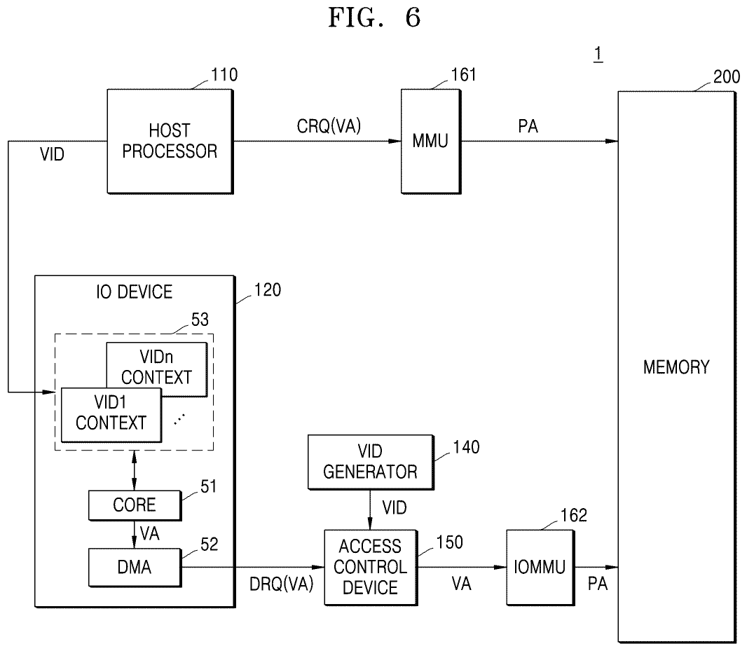

The access control device 150 may allow or block access to the IO devices 121 through 12m, based on the virtual identification VID set in the VID generator 140 and the virtual address included in the DMA request. The access control device 150 may obtain the virtual identification VID from the VID generator 140, and obtain the virtual address by using the DMA request. The access control device 150 may search for the access control table ACT and the access control table address register ACTAR, and may check whether the obtained virtual identification VID has been mapped to the virtual address. When the obtained virtual identification VID and the virtual address are mapped, the access control device 150 may allow the IO devices 121 through 12m to access the memory 200, and when the obtained virtual identification VID and the virtual address are not mapped, the access control device 150 may block the access of the IO devices 121 through 12m to the memory 200. In some implementations, the access control device 150 may allow or block access to the IO devices 121 through 12m, based on the virtual identification VID set in the VID generator 140 and the physical address. The access control device 150 may obtain the virtual identification VID from the VID generator 140, and obtain the physical address from an input/output memory management unit (IOMMU) (for example, 162 in FIG. 6). The access control device 150 may search for the access control table ACT and the access control table address register ACTAR, and may check whether the obtained virtual identification VID and the physical address have been mapped. When the obtained virtual identification VID and the physical address are mapped, the access control device 150 may allow the IO devices 121 through 12m to access the memory 200, and when the obtained virtual identification VID and the physical address are not mapped, the access control device 150 may block the access of the IO devices 121 through 12m to the memory 200.

The hypervisor 30 according to an embodiment may enable the memory isolation between each of the guest virtual machines GVM1 through GVMn by controlling the access control device 150 and the VID generator 140, and thus provide improved security performance. Memory isolation may mean that one virtual machine is not allowed to access a memory allocated to another virtual machine.

In FIG. 2, the host applications HAPP, the host operating system HOS, the guest applications GAPP, the guest operating system GOS, and the hypervisor 30 may include software programs, and may be loaded onto the memory 200 and executed by the host processor 110.

The memory 200 may store data and program code, and software programs, such as the host applications HAPP, the host operating system HOS, the guest applications GAPP, the guest operating system GOS, and the hypervisor 30, which implement the virtualized environment, may be loaded onto the memory 200. The memory 200 may function as a working memory of the virtualized system 2.

The hardware 40 may be controlled by the host operating system HOS, the guest operating system GOS, and the hypervisor 30. The hypervisor 30 may generate, schedule, and manage the virtual machines. The hypervisor 30 may provide an interface between the virtual machines and the hardware 40, and may manage execution of instructions related with the virtual machines and data transmission. The hypervisor 30 may also be referred to as a virtual machine monitor or a virtual machine manager.

FIG. 5 is a block diagram showing an example of a virtualized system according to some implementations. In FIG. 5, a virtualized system 2 may include the memory allocator MA. The memory allocator MA may allocate addresses of the memory 200 to the guest virtual machines GVM1 and GVM2 (\textcircled{1}). An address allocated to a virtual machine may be referred to as a virtual address. The memory allocator MA may allocate first addresses among the addresses of the storage areas of the memory 200 to the guest virtual machine GVM1, and allocate second addresses to the guest virtual machine GVM2. Data VM1 DATA accessed by the guest virtual machine GVM1 may be stored in the storage areas of the first addresses, and Data VM2 DATA accessed by the guest virtual machine GVM2 may be stored in the storage areas of the second addresses.

The memory allocator MA may provide the protection request PT_RQ to the protection manager PRTMNG of the hypervisor 30 (\textcircled{5}). The protection request PT_RQ may include the virtual machine identifier VMID, a virtual address ADDR, and the device identifier DevID of the IO device 120. In other words, the memory allocator MA may request protection of the virtual machine identified by the virtual machine identifier VMID for accessing the virtual address ADDR, by controlling the IO device identified by the device identifier DevID. The virtual machine identifier VMID may include a virtual machine identifier of the guest virtual machine GVM1 or a virtual machine identifier of the guest virtual machine GVM2. The virtual address ADDR may include a first address allocated to the guest virtual machine GVM1 or a second address allocated to the guest virtual machine GVM2.

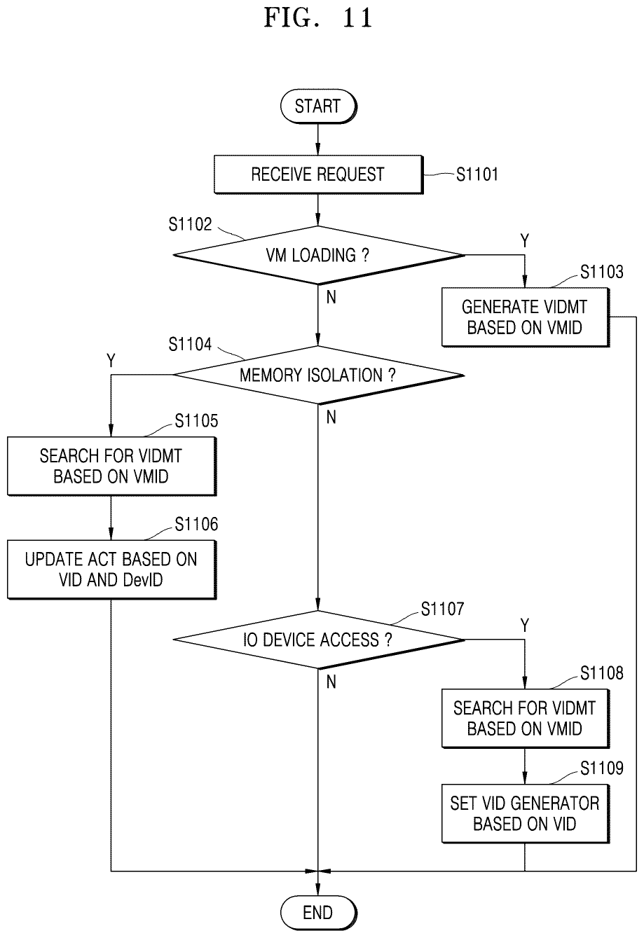

The protection manager PRTMNG may set the virtual identifier mapping table (for example, VIDMT in FIG. 4) (\textcircled{3}). The protection manager PRTMNG may search for the virtual identification VID mapped to the virtual machine identifier VMID, based on the virtual identifier mapping table VIDMT. The mapping information between virtual machine identifiers VMID1 and VMID2 and the virtual identifiers VID1 and VID2 may have been updated in the virtual identifier mapping table VIDMT. For example, while the guest virtual machines GVM1 and GVM2 are generated (for example, while operation S1102 in FIG. 11 is being performed), the protection manager PRTMNG may update the mapping information between the virtual machine identifiers VMID1 and VMID2 and the virtual machine identifiers VMID1 and VMID2 onto the virtual identifier mapping table VIDMT.

The protection manager PRTMNG may set the access control device (for example, ACT in FIG. 3) by using the access control device 150 (\textcircled{4}). The protection manager PRTMNG may obtain the virtual identification VID mapped onto the virtual machine identifier VMID based on the virtual identifier mapping table VIDMT, and set the access control table ACT based on the virtual identification VID. For example, the access control device 150 may store the mapping information between the device identifier DevID, the virtual identification VID, and the virtual address ADDR in the access control table (for example, ACT in FIG. 3) and the access control table address register (for example, ACTAR in FIG. 3). In some embodiments, the protection manager PRTMNG may convert the virtual address ADDR into a physical address, and based on the converted physical address, may set the access control table (for example, ACT in FIG. 3) and the access control table address register (for example, ACTAR in FIG. 3). In other words, the protection manager PRTMNG may store the mapping information between the device identifier DevID, the virtual identification VID, and the physical address in the access control table (for example, ACT in FIG. 3) and the access control table address register (for example, ACTAR in FIG. 3).

The memory allocator MA may provide memory allocation information MA INFO to the guest virtual machines GVM1 and GVM2 (\textcircled{5}). The memory allocation information MA INFO may include information about the addresses allocated to the guest virtual machines GVM1 and GVM2.

A front-end device driver FDDRV1 of the guest virtual machine GVM1 may provide a first usage request URQ1 for the IO device 120 to the host virtual machine HVM, and a front-end device driver FDDRV2 of the guest virtual machine GVM2 may provide a second usage request URQ2 for the IO device 120 to the host virtual machine HVM (\textcircled{6}). The first usage request URQ1 may include the virtual machine identifier VMID1 of the guest virtual machine GVM1, a first address ADDR1, and the device identifier DevID of the IO device 120, and the second usage request URQ2 may include the virtual machine identifier VMID2, a second address ADDR2, and the device identifier DevID of the IO device 120. The first address ADDR1 and the second address ADDR2 may include virtual addresses. The first and second usage requests URQ1 and URQ2 may be stored in a request queue RQ QUEUE.

The back-end device driver BDDRV may generate an access request ACT_RQ based on a usage request stored in the request que RQ QUEUE, and provide the access request ACT_RQ to the protection manager PRTMNG (\textcircled{7}). For example, the usage requests stored in the request que RQ QUEUE may be sequentially provided to the back-end device driver BDDRV. In FIG. 5, the back-end device driver BDDRV may provide the access request ACT_RQ corresponding to the first usage request URQ1 to the protection manager PRTMNG. The access request ACT_RQ may include the virtual machine identifier VMID1 of the guest virtual machine GVM1, the first address ADDR1, and the device identifier DevID of the IO device 120.

The protection manager PRTMNG may set the virtual identification VID in the VID generator 140 (\textcircled{8}). The protection manager PRTMNG may obtain the virtual identification VID corresponding to the virtual machine identifier VMID1, based on the virtual identifier mapping table VIDMT, and store the obtained virtual identification VID in the VID generator 140.

The back-end device driver DBBRV may generate a device control signal DCTRL based on the first usage request URQ1, and provide the device control signal DCTRL to the IO device 120 (\textcircled{9}). The device control signal DCTRL may include the first address ADDR1.

A DMA circuit 52 included in the IO device 120 may access the data VM1 DATA based on the device control signal DCTRL (\textcircled{10}). In other words, the DMA circuit 52 may access the storage area corresponding to the first address ADDR1, based on the device control signal DCTRL. The access control device 150 may allow or block the access to the DMA circuit 52. The DMA circuit 52 may provide the DMA request including the first address ADDR1 and the device identifier DevID to the access control device 150. The access control device 150 may obtain a virtual identification VID1 from the VID generator 140, obtain the first address ADDR1 and the device identifier DevID by using the DMA request, search for the access control table ACT based on the virtual identification VID1, the first address ADDR1, and the device identifier DevID, and based on the searching result, allow or block access of the IO device 120 to the first address ADDR1. In some embodiments, the access control device 150 may obtain the physical address for the first address ADDR1 from the IOMMU (for example, 162 in FIG. 6), search for the access control table ACT based on the physical address for the first address ADDR1 and the device identifier DevID, and based on the searching result, allow or block access of the IO device 120 to the first address ADDR1.

A core 51 included in the IO device 120 may perform calculation on the data VM1 DATA accessed via the DMA circuit 52.

The back-end device driver BDDRV may provide, to the front driver FDDRV1, a reply that access of the IO device 120 to the first address ADDR1 has been completed.

In FIG. 5, an example in which the access control device 150 either blocks or allows access of the IO device 120 to the memory 200, based on the first usage request URQ1, is described, but the present disclosure is not limited thereto. In other words, the access control device 150 may also block or allow access of the IO device 120 to the memory 200, based on the second usage request URQ2.

According to some implementations, because the access control device 150 controls a virtual machine such that the virtual machine accesses only to addresses allocated in advance via the IO device 120, data confidentiality between virtual machines may be provided. Although only the IO device 120 is illustrated in FIG. 5, the virtualized system 2 may include the plurality of IO devices 121 through 12m as illustrated in FIG. 1, and the access control device 150 may allow or block access of the plurality of IO devices 121 through 12m to the memory 200, based on the device identifier DevID. In other words, because a plurality of virtual machines may control in parallel different IO devices by using a device identifier, the IO devices may be efficiently utilized.

According to some implementations, because different virtual identifiers VID are set in the VID generator 140 according to the virtual machines driving the host processor 110, and the access control device 150 controls access of the IO device 120 to the memory 200, based on the virtual identifiers VID of the VID generator 140, the plurality of virtual machines may efficiently share one IO device 120.

FIG. 6 is a block diagram showing an example of a electronic device according to some implementations. In FIG. 6, an electronic device 1 may include the host processor 110, the IO device 120, a memory management unit (MMU) 161, an IOMMU 162, the VID generator 140, the access control device 150, and the memory 200.

The host processor 110 may access the memory 200 based on a core access request CRQ. The core access request CRQ may include a virtual address VA for a data write operation or a data read operation. The MMU 161 may perform an address conversion operation of converting the virtual address VA into a physical address PA. For example, the MMU 161 may convert the virtual address VA into the physical address PA, based on a page table stored in the memory 200. For example, the MMU 161 may store recently-converted address conversion information in a translation lookaside buffer (TLB), and based on the TLB, may also convert the virtual address VA into the physical address PA. The memory controller (for example, 130 in FIG. 1) may access the memory 200 based on the physical address PA.

The IO device 120 may have a direct memory access function on the memory 200. The IO device 120 may access the memory 200 based on a DMA request DRQ. The DMA request DRQ may include a virtual address VA for a data write operation or a data read operation. The IOMMU 162 may perform an address conversion operation of converting the virtual address VA into the physical address PA. For example, the IOMMU 162 may convert the virtual address VA into the physical address PA, based on a page table stored in the memory 200. For example, the IOMMU 162 may store recently-converted address conversion information in the TLB, and based on the TLB, may also convert the virtual address VA into the physical address PA. The memory controller (for example, 130 in FIG. 1) may access the memory 200 based on the physical address PA. In some embodiments, at least one of the VID generator 140 and the access control device 150 may also include the IOMMU 162.

In FIG. 6, because the direct memory access function does not need intervention of the host processor 110 while the accessing the memory 200, the host processor 110 may perform other operations, and performance of the electronic device 1 may be improved.

The IO device 120 may include the core 51, the DMA circuit 52, and a device memory 53. The core 51 may execute commands corresponding to various software (an application program, an operating system, a device driver). The IO device 120 may include one or more homogeneous or heterogeneous core(s). The core 51 may process a usage request of a virtual machine, based on contexts VID1 CONTEXT to VIDn CONTEXT stored in the device memory 53.

The device memory 53 may store the contexts VID1 CONTEXT to VIDn CONTEXT respectively corresponding to the virtual identifiers VID1 through VIDn. The device memory 53 may also be referred to as a register or a register file. The contexts VID1 CONTEXT to VIDn CONTEXT may be stored in different registers from each other. Each of the contexts VID1 CONTEXT to VIDn CONTEXT may include a data set for processing a usage request of a virtual machine. For example, each of the contexts VID1 CONTEXT to VIDn CONTEXT may include data, variables, or the like to be used for calculation to process a request of a virtual machine. The device memory 53 may store various pieces of information for controlling the IO device 120. In other words, the host processor 110 may control the IO device 120 by using the device memory 53. For example, by storing control information in the device memory 53, the host processor 110 may control the IO device 120 so that the IO device 120 may directly access a memory 200. Furthermore, the host processor 110 may, by using the device memory 53, monitor a device state of the IO device 120, perform power management, or execute kernel in the IO device 120. In some embodiments, the contexts VID1 CONTEXT to VIDn CONTEXT may also include TLB which includes mapping information for converting a virtual address into a physical address or page table information.

In FIG. 6, the host processor 110 may provide the virtual identification VID to the IO device 120. The protection manager PRTMNG executed by the host processor 110 may convert the virtual machine identifier VMID into the virtual identification VID, and provide the virtual identification VID to the IO device 120. In some implementations, the host processor 110 may provide information that the virtual identification VID has been switched to the IO device 120. virtual identification VID switching information may be stored in the device memory 53.

The IO device 120 may select one of the contexts VID1 CONTEXT to VIDn CONTEXT based on the virtual identification VID provided by the host processor 110, and the core 51 may process the usage request of a virtual machine, based on the selected context. The core 51 may generate the virtual address VA for accessing the memory 200 based on the selected context. In some embodiments, the IO device 120 may obtain the virtual identification VID from the VID generator 140, in response to the virtual identification VID switching information, and based on the obtained virtual identification VID, may also select one of the contexts VID1 CONTEXT to VIDn CONTEXT.

The DMA circuit 52 may provide the DMA request DRQ including the virtual address VA to the access control device 150. However, the present disclosure is not limited thereto, and the DMA circuit 52 may also provide the DMA request DRQ to the IOMMU 162.

In FIG. 6, the access control device 150 may obtain the virtual identification VID from the VID generator 140, and obtain the virtual address VA included in the DMA request DRQ. The access control device 150 may allow or block access of the DMA circuit 52 to the memory 200, based on the access control table ACT. When the mapping information between the virtual identification VID and the virtual address VA is searched for by using the access control table ACT, the access control device 150 may allow access to the DMA circuit 52. When the mapping information between the virtual identification VID and the virtual address VA is not searched for by using the access control table ACT, the access control device 150 may block an access to the DMA circuit 52. However, the present disclosure is not limited thereto, and the access control device 150 may obtain the virtual identification VID from the VID generator 140, and may obtain the physical address PA mapped to the virtual address VA from the IOMMU 162. When the mapping information between the virtual identification VID and the physical address PA is searched for by using the access control table ACT, the access control device 150 may allow access to the DMA circuit 52. When the mapping information between the virtual identification VID and the physical address PA is not searched for by using the access control table ACT, the access control device 150 may block access to the DMA circuit 52.

According to some implementations, the IO device 120 may store contexts per the virtual identification VID, select one of the contexts according to the virtual identification VID, and access the memory 200 based on the selected context. Accordingly, the virtual machines may effectively share the IO device 120.

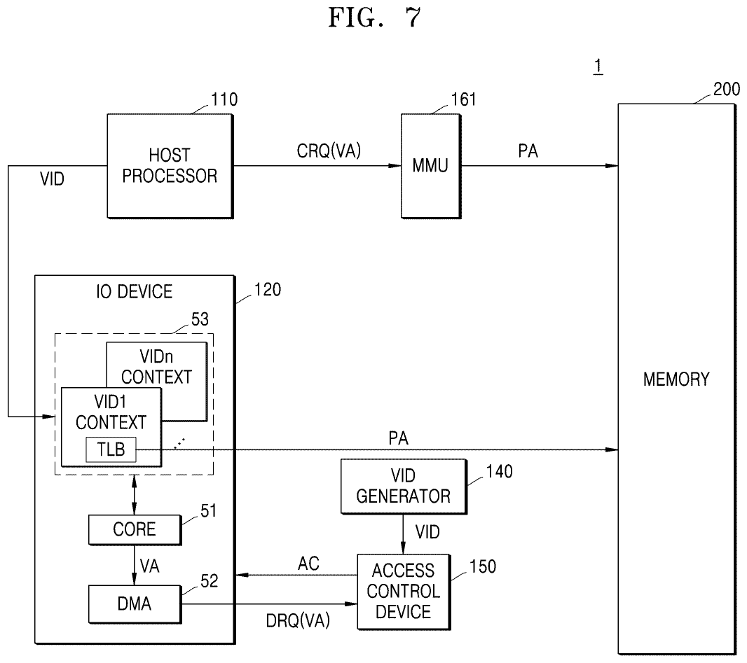

FIG. 7 is a block diagram of an example of a electronic device according to some implementations. In FIG. 7, the contexts VID1 CONTEXT to VIDn CONTEXT may include TLB information. The TLB information may include mapping information between the virtual address VA and the physical address PA, which are frequently accesses.

Depending on whether the mapping information between the virtual identification VID and the virtual address VA are searched for by using the access control table ACT, the access control device 150 may provide an access signal AC to the IO device 120. For example, when the mapping information between the virtual identification VID and the virtual address VA is searched for by using the access control table ACT, the access signal AC may indicate access permit, the IO device 120 may convert the virtual address VA into the physical address PA based on the TLB information, and access the memory 200 based on the physical address PA. When the mapping information between the virtual identification VID and the virtual address VA is not searched for by using the access control table ACT, the access signal AC may indicate access blocking, and the IO device 120 may not access the memory 200.

In some implementations, depending on whether the mapping information between the virtual identification VID and the physical address PA provided by the IOMMU 162 is searched for by using the access control table ACT, the access control device 150 may provide the access signal AC to the IO device 120.

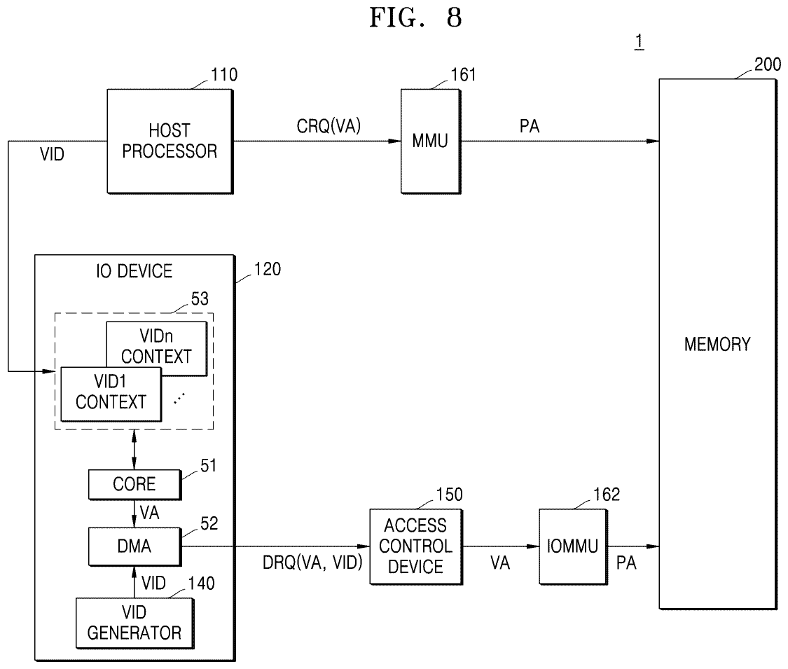

FIG. 8 is a block diagram showing an example of an electronic device according to some implementations. In FIG. 8, unlike as illustrated in FIG. 7, the IO device 120 may include the VID generator 140.

The DMA circuit 52 may obtain the virtual identification VID from the VID generator 140, and provide the DMA request DRQ including the virtual identification VID and the virtual address VA to the access control device 150. In some embodiments, the DMA circuit 52 may also provide the DMA request DRQ to the IOMMU 162.

The access control device 150 may obtain the virtual identification VID and the virtual address VA from the DMA request DRQ. The access control device 150 may allow or block access of the DMA circuit 52 to the memory 200, based on the access control table ACT. In some implementations, the access control device 150 may obtain the virtual identification VID and the physical address PA from the IOMMU 162.

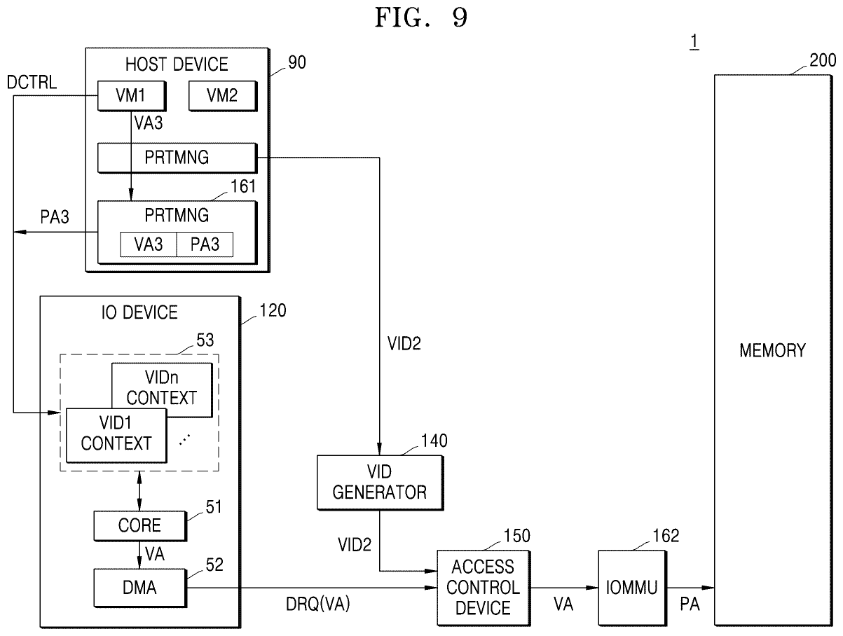

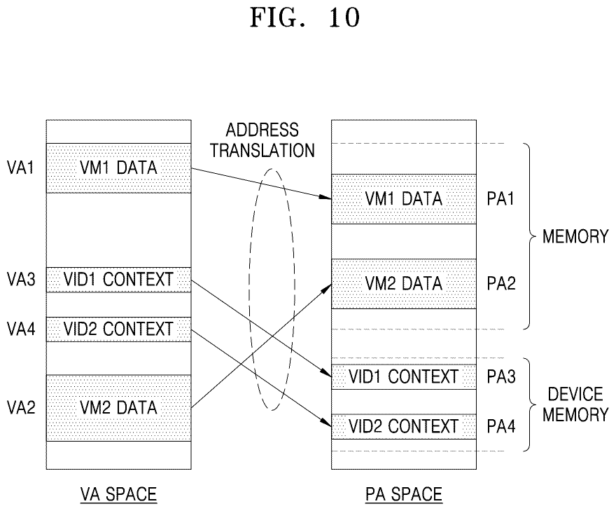

FIG. 9 is a block diagram showing an example of an electronic device according to some implementations. FIG. 10 is a diagram showing an example of an address conversion operation according to some implementations.

In FIG. 9, an electronic device 1 may include a host device 90. For example, the host device 90 may include the host processor 110 and the MMU 161 in FIGS. 6 through 8. The virtual machines VM1 and VM2 and the protection manager PRTMNG may be executed by the host processor 110. The virtual machine VM1 may include a host virtual machine, and the virtual machine VM2 may include a guest virtual machine.

The protection manager PRTMNG may individually grant, to virtual machines, control authority over the IO device 120, and control authority over the memory access of the IO device 120. The protection manager PRTMNG may use the MMU 161 to grant control authority over the IO device 120 to a virtual machine, and may use the VID generator 140 and the access control device 150 to grant control authority over the memory access of the IO device 120 to the virtual machine.

By storing the mapping information between a virtual address VA3 and a physical address PA3, the protection manager PRTMNG may grant control authority over the IO device 120 to the virtual machine VM1. In FIG. 10, the virtual address VA3 and the physical address PA3 may indicate a storage location of the context VID1 CONTEXT stored in the device memory (for example, 53 in FIG. 6). Accordingly, the virtual machine VM1 may access the context VID1 CONTEXT based on the physical address PA3, and by updating the context VID1 CONTEXT based on the device control signal DCTRL, may control the IO device 120. By excluding the mapping information about a virtual address VA4 and a physical address PA4, the protection manager PRTMNG may block access of the virtual machine VM2 to a storage location of the context VID2 CONTEXT. Accordingly, the control authority of the virtual machine VM2 over the IO device 120 may be blocked. However, the embodiment is not limited thereto, and by updating the mapping information stored in the MMU 161, the protection manager PRTMNG may also grant control authority over the IO device 120 only to the virtual machine VM2.

By setting the virtual identification VID2 in the VID generator 140, the protection manager PRTMNG may grant control authority over the memory access of the IO device 120 to the virtual machine VM2. The access control device 150 may allow corresponding access only when there is an address mapped to the virtual identification VID2 in the access control table ACT. Accordingly, the access of the IO device 120 to the memory 200 may be controlled by the virtual machine VM2. However, the present disclosure is not limited thereto, and by changing the virtual identification VID stored in the VID generator 140, the protection manager PRTMNG may also grant control authority over the memory access of the IO device 120 only to the virtual machine VM1.

In FIG. 10, either the MMU 161 or the IOMMU (for example, 162 in FIG. 6) may perform the address conversion operation of converting a virtual address of a virtual address space VA address into a physical address of a physical address space PA space. The virtual address space VA space may include the virtual addresses VA1 and VA2 of the memory 200 where data VM1 DATA and data VM2 DATA respectively accessed by the virtual machine VM1 and the virtual machine VM2 are stored as well as the virtual addresses VA3 and VA4 of the device memory 53 where the contexts VID1 CONTEXT, VID2 CONTEXT are stored.

The physical address PA space may include the physical addresses PA1 and PA2 of the memory 200 where data VM1 DATA and data VM2 DATA respectively accessed by the virtual machines VM1 and VM2 are stored as well as the physical addresses PA3 and PA4 of the device memory 53 where the contexts VID1 CONTEXT, VID2 CONTEXT are stored.

In other words, the host processor 110 may access the memory 200, as well as the device memory 53. For example, the host processor 110 may access the device memory 53 in a memory-mapped IO (MMIO) manner.

FIG. 11 is a flowchart of an example of an operating method of a hypervisor according to some implementations. FIG. 11 may be described with reference to FIGS. 2 and 5.

The hypervisor 30 may receive requests from the host virtual machine HVM or the guest virtual machines GVM1 through GVMn (S1101).

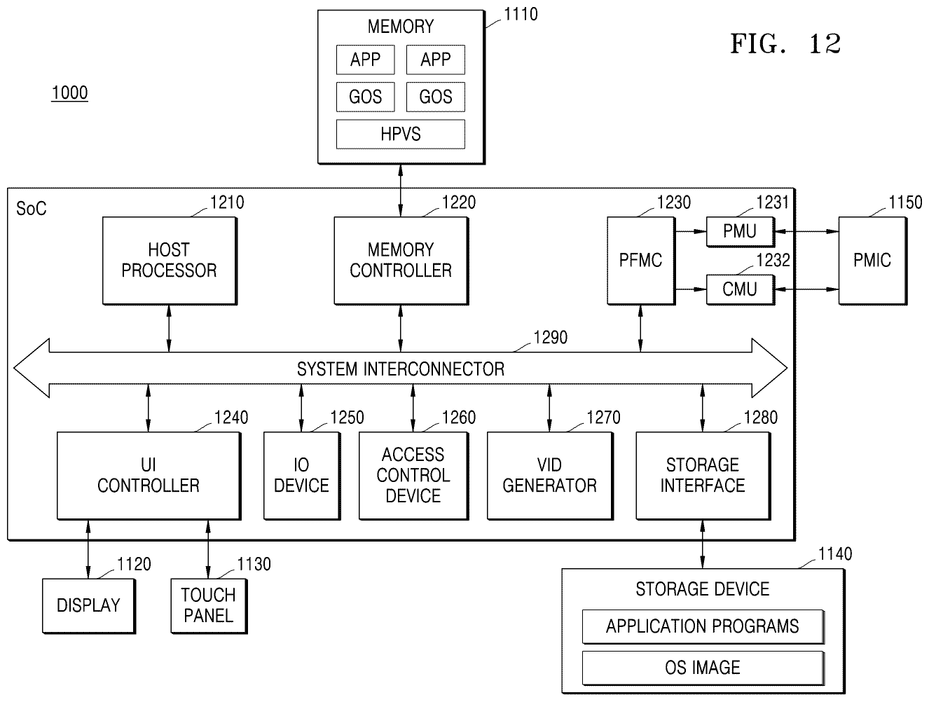

When there is a request of loading a virtual machine from a storage device (for example, 1140 in FIG. 12) onto the memory 200 (S1102=Y), while the virtual machine is loaded, that is, while the virtual machine is generated, the hypervisor 30 may generate the virtual identification VID mapped onto the virtual machine identifier VMID of the loaded virtual machine, and generate the virtual identifier mapping table VIDMT (S1103).

When there is a request of isolating a memory for an address allocated to the virtual machine (S1104=Y), the hypervisor 30 may search for the virtual identifier mapping table VIDMT based on the virtual machine identifier VMID (S1105). The hypervisor 30 may obtain the virtual identification VID from the virtual identifier mapping table VIDMT. The hypervisor 30 may update the access control table ACT based on the virtual identification VID and the device identifier DevID of an IO device which a virtual machine request access (S1106). Operations of the virtualized system 2 responding to a request for isolating a memory may include operations \textcircled{2} through \textcircled{5} in FIG. 5.

When the virtual machine requests a memory access of the IO device (S1107=Y), the hypervisor 30 may search for the virtual identifier mapping table VIDMT based on the virtual machine identifier VMID (S1108). The hypervisor 30 may set the VID generator 140 based on the virtual identification VID. Operations of the virtualized system 2 responding to a memory access request of the IO device may include operations \textcircled{6} through \textcircled{10} in FIG. 5.

FIG. 12 is a block diagram showing an example of an electronic device according to some implementations. In FIG. 12, an electronic device 1000 may include a system-on-chip SoC, a memory 1110, a display 1120, a touch panel 1130, a storage device 1140, and a power management integrated circuit (PMIC) 1150.

The system-on-chip SoC may include a host processor 1210, a memory controller 1220, a performance controller (PFMC) 1230, a user interface (UI) controller 1240, an IO device 1250, an access control device 1260, a VID generator 1270, a storage interface 1280, a power management unit (PMU) 1231, a clock management unit (CMU) 1232, etc. Each of components of the system-on-chip SoC may be referred to as an IP block. It should be understood that the components of the electronic device 1000 are not limited to those illustrated in FIG. 12. For example, the electronic device 1000 may further include a hardware codec for processing image data, security blocks, etc.

The host processor 1210 may execute software to be executed by the electronic device 1000 (application programs, operating systems, and device drivers). The host processor 1210 may execute an operating system OS loaded onto the memory 1110. In addition, the host processor 1210 may execute various application programs to be run on an operating system OS basis. The host processor 1210 may be provided as a homogeneous multi-core processor or a heterogeneous multi-core processor. A multi-core processor may include computing components including at least two independently runnable processor cores (hereinafter, cores). Each core may independently read program instructions and execute them.

The memory controller 1220 may provide an interface between the memory 1110 and the system-on-chip SoC. The memory controller 1220 may access the memory 1110 according to a request of the host processor 1210 or the IO device 1250. In the embodiment, the memory 200 may be implemented as DRAM, and in this case, the memory controller 1220 may be referred to as a DRAM controller.

The operating system OS or application programs may be loaded onto the memory 1110 at the time of booting. For example, a hypervisor HPVS and a plurality of guest operating systems GOS, which are stored in the storage device 1140, may be loaded onto the memory 1110 according to a booting sequence at the time of booting of the electronic device 1000. Thereafter, applications APP respectively corresponding to the plurality of guest operating systems GOS may be loaded onto the memory 1110.

The PFMC 1230 may adjust operation parameters of the system-on-chip SoC according to a control request provided by kernel of the operating system OS. For example, the PFMC 1230 may adjust the power level of dynamic voltage frequency scaling (DVFS) to increase performance of the system-on-chip SoC.

The UI controller 1240 may control an input and an output of a user from the UI devices. For example, the UI controller 1240 may show a keyboard screen for inputting data, or the like on the display 1120 according to the control by the host processor 1210. In some implementations, the UI controller 1240 may control the display 1120 to show data requested by the user. The UI controller 1240 may decode data provided by a user input tool such as the touch panel 1130 into user input data.

The storage interface 1280 may access the storage device 1140 according to a request of the host processor 1210. In other words, the storage interface 1280 may provide an interface between the system-on-chip SoC and the storage device 1140. Data processed by the host processor 1210 may be stored in the storage device 1140 via the storage interface 1280, and the data stored in the storage device 1140 may be provided to the host processor 1210 via the storage interface 1280.

The storage device 1140 may be provided as a storage medium of the electronic device 1000. The storage device 1140 may store application programs, operating system (OS) images, and various pieces of data. The storage device 1140 may also be provided as a memory card (a multi-media card (MMC), an embedded MMC (eMMC), a secure digital (SD) card, a microSD card, etc.). The storage device 1140 may include a NAND-type flash memory having a large storage capacity. In some implementations, the storage device 1140 may also include a next generation non-volatile memory, such as phase change RAM (PRAM), magnetoresistive RAM (MRAM), resistive RAM (ReRAM), and ferro-electric RAM (FRAM), or NOR flash memory.

A system interconnector 1290 may include a system bus for providing an on-chip network inside the system-on-chip SoC. The system interconnector 1290 may include, for example, a data bus, an address bus, and a control bus. The data bus may be a path through which data moves. Mainly, the data bus may be provided as a memory approach path to the storage device 1140. The address bus may provide address exchange paths between the IP blocks. The control bus may provide a path for transferring control signals between the IP blocks. However, a configuration of the system interconnector 1290 is not limited to previous descriptions, and may further include coordination tools for an efficient management.

The VID generator 1270 may store the virtual identification VID corresponding to a virtual machine driving the IO device 1250. The access control device 1260 may manage the mapping information between the virtual identification VID and the address ADDR. The access control device 1260 may obtain the virtual identification VID from the VID generator 1270 when the DMA request is received from the IO device 1250, obtain the address ADDR in response to the DMA request, and allow or block access of the IO device 1250 to the memory 1110 based on the mapping information.

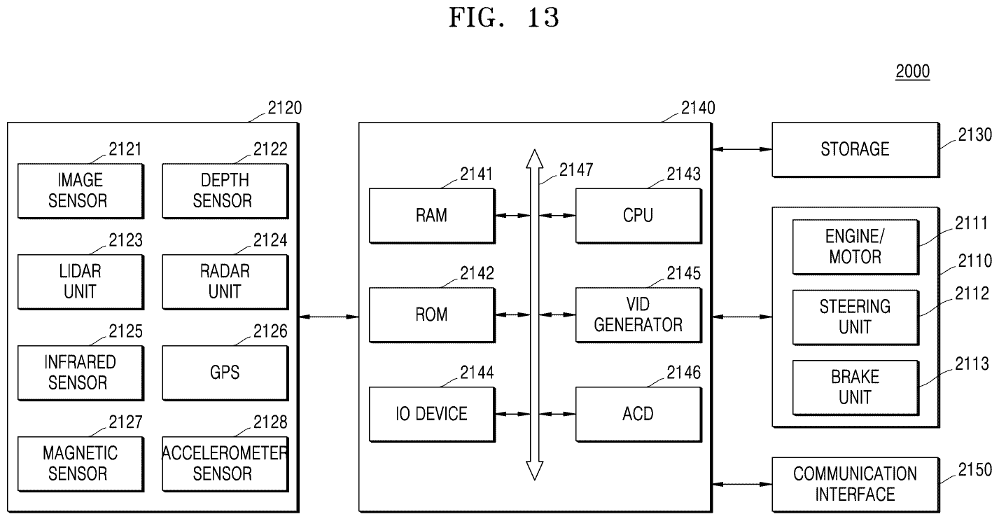

FIG. 13 is a block diagram showing an example of an autonomous driving system according to some implementations. In FIG. 13, an autonomous driving system 2000 may include a driving unit 2110, a sensing unit 2120, a storage 2130, a control unit 2140, and a communication interface 2150.

The driving unit 2110 may include various devices and units for driving the autonomous driving system 2000. For example, when the autonomous driving system 2000 is a device driving on the ground, the driving unit 2110 may include an engine/motor 2111, a steering unit 2112, a brake unit 2113, etc.

The engine/motor 2111 may include a combination of an internal combustion engine, an electric motor, a steam engine, and a Stirling engine. For example, when the autonomous driving system 2000 is a gas-electric hybrid car, the engine/motor 2111 may include a gasoline engine and an electric motor. As an example, the engine/motor 2111 may provide power with which the autonomous driving system 2000 may drive on a preset driving path.

The steering unit 2112 may be a combination of mechanisms configured to adjust the direction of the autonomous driving system 2000. As an example, when the autonomous driving system 2000 recognizes an obstacle during driving, the steering unit 2112 may change the direction of the autonomous driving system 2000. When the autonomous driving system 2000 is a car, the steering unit 2112 may change the direction of the autonomous driving system 2000 as the steering wheel rotates in a clockwise direction or a counterclockwise direction.

The brake unit 2113 may be a combination of mechanisms configured to decelerate the autonomous driving system 2000. For example, the brake unit 2113 may use friction to reduce the speed of wheels/tires. The brake unit 2113 may decelerate the autonomous driving system 2000 when the autonomous driving system 2000 recognizes an obstacle during the driving.

The driving unit 2110 may not be limited to a driving unit of the autonomous driving system 2000 which drives on the ground, but may include a flight propulsion unit, a propeller, a wing, or the like, and various ship propelling units.

The sensing unit 2120 may include various sensors configured to sense information about the surrounding environment of the autonomous driving system 2000. For example, the sensing unit 2120 may include at least one of an image sensor 2121, a depth sensor 2122, a light detection and ranging (LIDAR) unit 2123, a radio detection and ranging (RADAR) unit 2124, an infrared sensor 2125, a global positioning system (GPS) 2126, a magnetic geomagnetic sensor 2127, and an accelerometer sensor 2128.

The image sensor 2121 may shoot an external object outside the autonomous driving system 2000. The shot external object may be used as data for changing at least one of speed and direction of the autonomous driving system 2000. The image sensor 2121 may be implemented as various types of sensors, such as a charge coupled device (CCD) sensor and a complementary metal-oxide semiconductor (CMOS) sensor. In addition, the depth sensor 2122 may obtain information for determining a distance between the autonomous driving system 2000 and the external object.

The LIDAR unit 2123, the RADAR unit 2124, and the infrared sensor 2125 may include sensors configured to sense, by outputting particular signals, the external objects in the environment where the autonomous driving system 2000 is positioned. The LIDAR unit 2123 may include a laser light source and/or a laser scanner configured to emit laser, and a detector configured to detect reflection of laser. The RADAR unit 2124 may include a sensor configured to sense objects in the environment where the autonomous driving system 2000 is positioned. In addition, the RADAR unit 2124 may be configured to detect speeds and/or directions of the objects. The infrared sensor 2125 may include a sensor configured to detect, by using a light of wavelength in the infrared ray region, the external objects in the environment where the autonomous driving system 2000 is positioned.

The GPS 2126, the magnetic sensor 2127, and the accelerometer sensor 2128 may include sensors configured to obtain information about speed, direction, position, etc. In other words, the GPS 2126, the magnetic sensor 2127, and the accelerometer sensor 2128 may obtain information about the present state to determine collision possibility or the like with respect to the external object. The GPS 2126 may receive, by using an artificial satellite, the position, such as latitude and longitude of the autonomous driving system 2000, and the magnetic sensor 2127 and the accelerometer sensor 2128 may determine the present state of the autonomous driving system 2000 according to a movement amount of the autonomous driving system 2000.

The storage 2130 may store data necessary for the controller 2140 to execute various operations. As an example, the storage 2130 may be implemented as device memories, such as read-only memory (ROM) and RAM included in the controller 2140, or may also be implemented as a memory separate from the controller 2140. In this case, the storage 2130 may be implemented as a memory type embedded in the autonomous driving system 2000 according to the purpose of data storage, or may also be implemented as a memory type detachable from the autonomous driving system 2000.

For example, when data is for driving the autonomous driving system 2000, the data may be stored in a memory embedded in the autonomous driving system 2000, and when data is for expanded functions of the autonomous driving system 2000, the data may be stored in a memory detachable from the autonomous driving system 2000.

On the other hand, when the memory is embedded in the autonomous driving system 2000, the memory may be implemented in a type, such as a non-volatile memory, a volatile memory, a flash memory, a hard disk drive (HDD), and a solid state drive (SSD), and when the memory is detachable from the autonomous driving system 2000, the memory may be implemented in a type, such as a memory card (for example, a micro SD card, a USB memory, or the like), and an external memory connectable to a USB port (for example, a USB memory).

The communication interface 2150 may perform communication between the autonomous driving system 2000 and an external device. As an example, the communication interface 2150 may transceive driving information of the autonomous driving system 2000 and the external device. For example, the communication interface 2150 may perform communication in various communication methods, such as infrared (IR) communication, wireless fidelity (WI-FI), Bluetooth, Zigbee, a beacon, near field communication (NFC), wide area network (WAN), Ethernet, IEEE 1394, high-definition multimedia interface (HDMI), USB, Mobile high-definition link (MHL), Audio Engineering Society/European Broadcast Union (AES/EBU), optical, and coaxial. However, depending on the cases, the communication interface 2150 may also perform communication of driving information via a server (not illustrated).

The control unit 2140 may include a RAM 2141, a ROM 2142, a CPU 2143, an IO device 2144, a VID generator 2145, an access control device (ACD) 2146, and a bus 2147. The RAM 2141, the ROM 2142, the CPU 2143, the IO device 2144, the VID generator 2145, and the ACD 2146 may be connected to each other via the bus 2147, and at least two components may be directly connected to each other via a direct signal line. In some implementations, the control unit 2140 may be implemented as an SoC.

The RAM 2141 may include a memory for loading various commands, instructions, or the like, which are read from the storage 2130, related to driving of the autonomous driving system 2000. In the ROM 2142, command sets for system booting, or the like may be stored. When a turn-on command is input into the autonomous driving system 2000 and the power is supplied to the autonomous driving system 2000, the CPU 2143 may copy an operating system (O/S) stored in the storage 2130 onto the RAM 2141 according to the instruction stored in the ROM 2142, and execute the O/S to boot the system. When the booting is completed, the CPU 2143 may copy various application programs stored in the storage 2130 onto the RAM 2141, execute the application programs copied onto the RAM 2141 to perform various operations. The control unit 2140 may perform various operations by using modules stored in the storage 2130.

According some implementations, the CPU 2143 may provide a hypervisor and virtualized environment including a plurality of guest operating systems. The hypervisor may control the VID generator 2145 and the ACD 2146 so that the IO device 2144 may access the storage areas respectively different for the virtual machines.

The VID generator 2145 may store a virtual identifier corresponding to a virtual machine driving the IO device 2144, and the ACD 2146 may allow or block access of the IO device 2144 to the RAM 2141 based on machine about the virtual identifier and an address.

While this disclosure contains many specific implementation details, these should not be construed as limitations on the scope of what may be claimed, equivalents thereof, as well as claims to be described later. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

What is claimed is:

1. A system-on-chip comprising:
an input output (IO) device configured to perform a direct memory access operation on a memory;
an access control device configured to search for mapping information between a plurality of virtual identifiers respectively corresponding to a plurality of virtual machines, and block the direct memory access operation based on a result of searching for the mapping information; and
a host processor configured to provide, to the access control device, a target address accessed by the direct memory access operation and a target virtual identifier corresponding to a driving virtual machine configured to drive the IO device.

2. The system-on-chip of claim 1, comprising a virtual identification (VID) generator configured to store the target virtual identifier,
wherein the access control device is configured to search for the mapping information based on the target virtual identifier stored in the VID generator and on the target address.

3. The system-on-chip of claim 2, wherein the IO device comprises registers configured to:
store data for processing requests of the plurality of virtual machines;
select, based on the target virtual identifier, a target register from the registers; and
perform, based on data stored in the target register, the direct memory access operation.

4. The system-on-chip of claim 3,
wherein each of the registers comprises conversion information between virtual addresses allocated to corresponding virtual machines and physical addresses of the memory, and
wherein the IO device is configured to convert the target address into a physical address, based on the conversion information stored in the target register.

5. The system-on-chip of claim 3, wherein the host processor is configured to:
convert, into a first physical address, a first virtual address of a first register configured to store data for processing a request of a first virtual machine among virtual addresses of the registers;
access the first register based on the first physical address; and
store a second virtual identifier of a second virtual machine as the target virtual identifier in the VID generator.

6. The system-on-chip of claim 1,
wherein the memory is configured to store an access control table comprising addresses of the memory mapped to the plurality of virtual identifiers, and
wherein the access control device comprises a register configured to store mapping information between an address of a storage area configured to store the access control table in the memory and a corresponding one of the virtual identifiers.

7. The system-on-chip of claim 1, wherein the access control device is configured to, based on mapping information about the target virtual identifier and the target address being included in the mapping information, allow the direct memory access operation.

8. The system-on-chip of claim 7, comprising:
an address conversion circuit configured to convert a virtual address of the memory into a physical address; and
a memory controller configured to access the memory based on the physical address,
wherein the access control device is configured to receive the target address from the address conversion circuit, and allow the direct memory access operation based on the target address.

9. The system-on-chip of claim 1,
wherein the IO device comprises a direct memory access (DMA) circuit configured to generate a direct memory access request including the target virtual identifier and the target address,
wherein the access control device is configured to obtain the target virtual identifier and the target address based on the direct memory access request.

10. A virtualized system comprising:
a memory;
a processor configured to provide a virtualized environment;
at least one input output (IO) device configured to perform a memory access operation on the memory;
a plurality of virtual machines configured to independently operate in the virtualized environment and generate requests for the memory access operation;
a virtual identification (VID) generator configured to store a virtual identifier of a driving virtual machine configured to drive the at least one IO device among the plurality of virtual machines;
an access control device configured to block the memory access operation based on first mapping information between a plurality of virtual identifiers respectively corresponding to the plurality of virtual machines and on the virtual identifier of the driving virtual machine; and
a hypervisor configured to control the plurality of virtual machines in the virtualized environment, update the first mapping information onto the access control device, and store the virtual identifier of the driving virtual machine in the VID generator.

11. The virtualized system of claim 10, wherein the hypervisor is configured to, based on the plurality of virtual machines being loaded onto the memory, generate second mapping information between virtual machine identifiers of the plurality of virtual machines and the plurality of virtual identifiers.

12. The virtualized system of claim 11, wherein the hypervisor is configured to, at a time of a memory isolation operation on the plurality of virtual machines, search for the second mapping information based on a virtual machine identifier of a first virtual machine among the plurality of virtual machines to obtain a first virtual identifier of the first virtual machine, and update the first mapping information based on the first virtual identifier of the first virtual machine and an address of the memory allocated to the first virtual machine.

13. The virtualized system of claim 12, wherein the hypervisor is configured to, in response to a request of the first virtual machine, search for the second mapping information based on the virtual machine identifier of the first virtual machine to obtain the first virtual identifier of the first virtual machine, and store the first virtual identifier of the first virtual machine in the VID generator.

14. The virtualized system of claim 10, wherein each of the at least one IO device comprising registers configured to store data for processing requests of the plurality of virtual machines, configured to:
select a target register from the registers based on the virtual identifier of the driving virtual machine; and
perform the memory access operation based on data stored in the target register.

15. The virtualized system of claim 14, comprising a memory management unit (MMU) circuit configured to convert virtual addresses of the registers into physical addresses,
wherein the hypervisor is configured to control the MMU circuit to convert a first virtual address of a first register to store data for processing a request of a first virtual machine among virtual addresses of the registers into a first physical address, and is configured to store a second virtual identifier of a second virtual machine in the VID generator.

16. An operating method of a virtualized system comprising at least one processor, the method comprising:
generating virtual identifiers mapped to virtual machine identifiers of a plurality of virtual machines;
allocating addresses of a memory to the plurality of virtual machines;
generating mapping information between the virtual identifiers of the plurality of virtual machines and the addresses allocated to the plurality of virtual machines;
obtaining a first virtual identifier mapped to a virtual machine identifier of a first virtual machine, based on a usage request for an input output (IO) device of the first virtual machine among the plurality of virtual machines;
searching for the mapping information, based on the first virtual identifier and a first address related to the usage request; and
controlling access to the memory of the IO device based on a result of searching for the mapping information.

17. The operating method of claim 16, wherein controlling access to the memory of the IO device comprises:
allowing access to the memory of the IO device based on mapping between the first virtual identifier and the first address being included in the mapping information; and
blocking access to the memory of the IO device based on the mapping between the first virtual identifier and the first address being not included in the mapping information.

18. The operating method of claim 17, wherein allowing access to the memory of the IO device comprises:
converting the first address into a physical address; and
accessing the memory based on the physical address.

19. The operating method of claim 16, comprising:
selecting, using the IO device, a first register based on the first virtual identifier among registers configured to store data for processing usage requests of the plurality of virtual machines; and
performing, using the IO device, access to the memory based on the data stored in the first register.

20. The operating method of claim 16, comprising:
selecting, using the IO device, a second register based on a second virtual identifier of a second virtual machine among registers configured to store data for processing usage requests of the plurality of virtual machines.
